(19) United States
(12) Patent Application Publication
(10) Pub. No.: US 2019/0179934 A1
(43) Pub. Date: Jun. 13, 2019

(54) CLOUD BASED VALIDATION ENGINE

(71) Applicant: SAP SE, Walldorf (DE)

(72) Inventors: Srujan Gogineni, Frisco, TX (US); Manish Jaiswal, Frisco, TX (US); Jennifer Chen, Los Gatos, CA (US)

(21) Appl. No.: 15/839,716

(22) Filed: Dec. 12, 2017

(51) Int. Cl. G06F 17/30; G06F 3/0484

(52) U.S. Cl. CPC G06F 17/30371; G06F 3/04842; G06F 17/30424; G06F 17/30011

(57) ABSTRACT

A method for validating structured data may include receiving, at a structured data validation engine and from a first client, a first request to validate an electronic document comprising structured data. The structured data validation engine may respond to the first request by at least identifying a set of validation rules for validating the structured data comprising the electronic document. The set of validation rules may be identified based at least on one or more attributes associated with the electronic document. The structured data validation engine may send, to a database storing a plurality of validation rules, one or more database queries to retrieve, from the database, a first validation rule included in the set of validation rules. The structured data may be validated by at least applying the first validation rule to the structured data. Related systems and articles of manufacture are also provided.

### TECHNICAL FIELD

The subject matter described herein relates generally to cloud computing and more specifically to a cloud based structured data validation engine.

### BACKGROUND

An electronic document may include structured data in the form of Extensible Markup Language (XML), JavaScript Object Notation (JSON), and/or the like. For example, an XML document may include a plurality of XML elements. Each XML element may be associated with a tag identifying the XML element as, for example, a heading, a paragraph, a table, a hyperlink, and/or the like. Alternatively and/or additionally, a JSON document may include a plurality of key value pairs. The key may be a string value identifying the corresponding value. Meanwhile, the value may be any type of data including, for example, an array, a Boolean value, a number, an object, a string, and/or the like. Structured data in the form of XML, JSON, and/or the like may enable a variety of electronic documents to be exchanged and/or accessed over the Internet.

### SUMMARY

Systems, methods, and articles of manufacture, including computer program products, are provided for cloud based structured data validation. In one aspect, there is provided a system. The system may include at least one data processor and at least one memory. The at least one memory may store instructions that result in operations when executed by the at least one data processor. The operations may include: receiving, at a structured data validation engine and from a first client, a first request to validate an electronic document comprising structured data; responding to the first request by at least identifying a set of validation rules for validating the structured data comprising the electronic document, the set of validation rules being identified by the structured data validation engine and being identified based at least on one or more attributes associated with the electronic document; sending, to a database storing a plurality of validation rules, one or more database queries to at least retrieve, from the database, a first validation rule included in the set of validation rules; and validating the structured data by at least applying the first validation rule to the structured data.

In some variations, one or more features disclosed herein including the following features can optionally be included in any feasible combination. A first user interface may be generated. The first user interface may include one or more input fields for entering the structured data and the one or more attributes associated with the electronic document. The first user interface may be displayed at the first client. The first request may be received via the first user interface.

In some variations, a second request to create the first validation rule may be received from the first client. Responding to the second request may include creating, at the database, one or more data objects corresponding to the first validation rule. A second user interface may be generated. The second user interface may include one or more input fields for entering a name of the first validation rule, a description of the first validation rule, and/or a type of electronic document associated with the first validation rule. The second user interface may be displayed at the first client. The second request may be received via the second user interface. The set of validation rules may further include a second validation rule created by a second client and/or a third validation rule provided by the structured data validation engine. The first validation rule may be an exclusive validation rule useable by the first client but not the second client. The second validation rule may be a shared validation rule useable by the first client and/or the second client.

In some variations, a third request to create the set of validation rules that includes the first validation rule, the second validation rule, and/or the third validation rule may be received from the first client. The third request may associate the set of validation rules with the one or more attributes such that the set of validation rules is applied to validate electronic documents having the one or more attributes. Responding to the third request may include creating, at the database, one or more data objects corresponding to the set of validation rules. The one or more attributes may include a type of the electronic document, a sender of the electronic document, and/or a receiver of the electronic document.

In some variations, a result of validating the structured data comprising the electronic document may be sent to the first client. The sending of the result may enable the result to be displayed by a browser at the first client. The structured data may be validated by at least executing programming code associated with the first validation rule. The structured data may include Extensible Markup Language (XML) and/or JavaScript Object Notation (JSON). The structured data validation engine may be a cloud-based platform.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to web application user interfaces, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts a system diagram illustrating a cloud based structured data validation system, in accordance with some example embodiments;

FIG. 1B depicts a block diagram illustrating a structured data validation engine, in accordance with some example embodiments;

FIG. 2 depicts a data model for storing validation rules and/or validation rule sets in a database, in accordance with some example embodiments;

FIG. 3A depicts a user interface for creating a custom validation rule, in accordance with some example embodiments;

FIG. 3B depicts a user interface for creating a validation rule set, in accordance with some example embodiments;

FIG. 3C depicts a user interface for validating structured data, in accordance with some example embodiments;

FIG. 4 depicts a flowchart illustrating a process for validating structured data, in accordance with some example embodiments; and

FIG. 5 depicts a block diagram illustrating a computing system, in accordance with some example embodiments.

When practical, similar reference numbers denote similar structures, features, or elements.

### DETAILED DESCRIPTION

Two or more entities may exchange electronic documents, which may include structured data in the form of, for example, Extensible Markup Language (XML), JavaScript Object Notation (JSON), and/or the like. Prior to accepting an electronic document, an entity may validate the electronic document in order to verify that the content and/or the format of an electronic document satisfy the requirements of the entity. The validation of structured data may be performed locally, for example, by the entity receiving the structured data. However, local validation of structured data may require a validation engine as well as a large database of validation rules to be deployed and maintained on premise. As such, local validation of structured data tends to be cost prohibitive.

In some example embodiments, the validation of structured data may be offloaded to be performed by a cloud based validation engine. The cloud based validation engine may be a multitenant application capable of validating structured data originating from multiple clients. Each client may create one or more custom validation rules, which may be stored at a database coupled with the cloud based validation engine. To validate structured data from a client, the cloud based validation engine may dynamically identify, based on the structured data, a set of applicable validation rules that includes custom validation rules and/or default validation rules provided by the cloud based validation engine. The cloud based validation engine may query the database to retrieve validation rules included in the set of application validation rules. The cloud based validation engine may further apply the set of applicable validation rules in order to validate the structured data from the client.

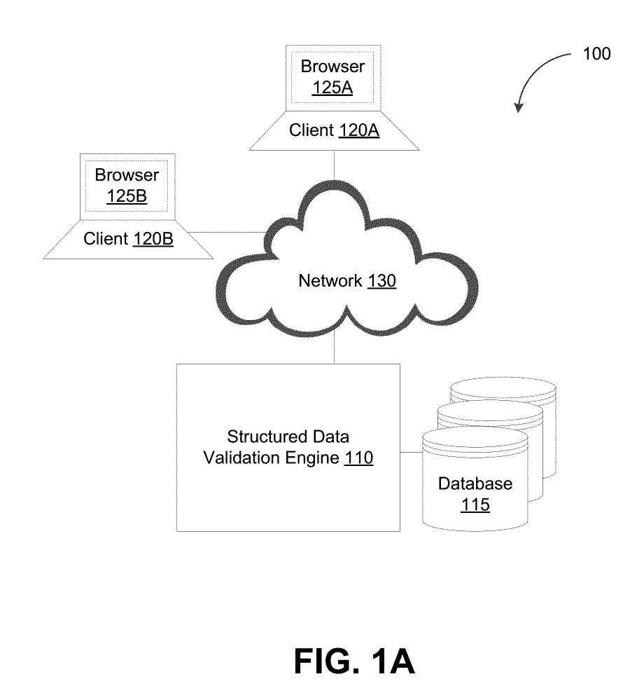

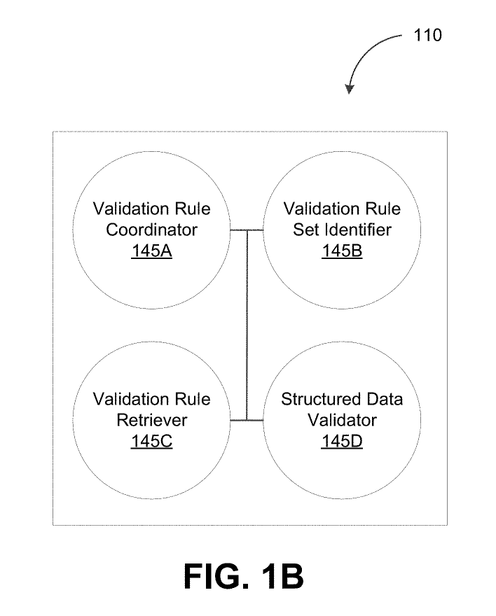

FIG. 1A depicts a system diagram illustrating a cloud based structured data validation system 100, in accordance with some example embodiments. Referring to FIG. 1A, the database system 100 may include a structured data validation engine 110, which may be coupled with a database 115. The database 115 may be any type of database including, for example, an in-memory database, a relational database, a non-SQL (NoSQL) database, and/or the like.

As shown in FIG. 1A, the structured data validation engine 110 may be communicatively coupled, via a network 130, with a plurality of clients including, for example, a first client 120A and a second client 120B. The first client 120A and/or the second client 120B may be any type of processor-based device including, for example, a smartphone, a tablet personal computer (PC), a desktop computer, a laptop computer, and/or the like. Meanwhile, the network 130 may be a wired and/or wireless network including, for example, a wide area network (WAN), a local area network (LAN), a public land mobile network (PLMN), the Internet, and/or the like.

In some example embodiments, the first client 120A and/or the second client 120B may interact with the structured data validation engine 110 to create, update, delete, and/or execute one or more validation rules stored in the database 115. For example, the first client 120A and/or the second client 120B may each create one or more custom validation rules, which may be stored in the database 115. Furthermore, the first client 120A and/or the second client 120B may send, to the structured data validation engine 110, structured data that may be validated by at least applying one or more validation rules from the database 115.

It should be appreciated one or more functionalities of the structured data validation engine 110 may be exposed as web services and accessed via an application programming interface (API). For instance, the structured data validation engine 110 may provide a Representational State Transfer (REST) API that enables the first client 120A and/or the second client 120B to interact with the structured data validation engine 110 via Hypertext Transfer Protocol (HTTP) methods such as, for example, post, get, put, patch, delete, and/or the like. Alternatively and/or additionally, the structured data validation engine 110 may provide a Simple Object Access Protocol (SOAP) API. To further illustrate, Table 1 below depicts REST API calls to the structured data validation engine 110 for retrieving, creating, updating, and/or deleting one or more validation rules.

TABLE 1

| name | method | url | description |
|---|---|---|---|
| getRules | GET | /Network/RuleEngine/rule | retrieve all rules together with |
| | | | their errors |
| create | POST | /Network/RuleEngine/rule | prepare and insert new rule and |
| | | | error |
| update | PUT | /Network/RuleEngine/rule{id} | update existing rule |
| delete | DELETE | /Network/RuleEngine/rule{id} | delete existing rule and error |

Table 2 below depicts REST API calls to the structured data validation engine 110 for retrieving, creating, updating, and/or deleting one or more validation rule sets.

TABLE 2

| name | method | url | description |
|---|---|---|---|
| getRuleSet | GET | /Network/RuleEngine/ruleset | retrieve all rulesets |
| create | POST | /Network/RuleEngine/ruleset | prepare and insert new |
| | | | ruleset |
| update | PUT | /Network/RuleEngine/ruleset{id} | update existing ruleset |
| delete | DELETE | /Network/RuleEngine/ruleset{id} | delete existing ruleset |

As noted, the first client 120A and/or the second client 120B may each create one or more custom validation rules. A custom validation rule may be an exclusive custom validation rule that may be used only by the client that created the custom validation rule or a shared custom validation rule that may be shared amongst multiple clients. For instance, the first client 120A may create an exclusive custom validation rule, which may be reserved for use only by the first client 120A. Alternatively and/or additionally, the first client 120A may create a shared custom validation rule that may be used by other clients of the structured data validation engine 110 including, for example, the second client 120B.

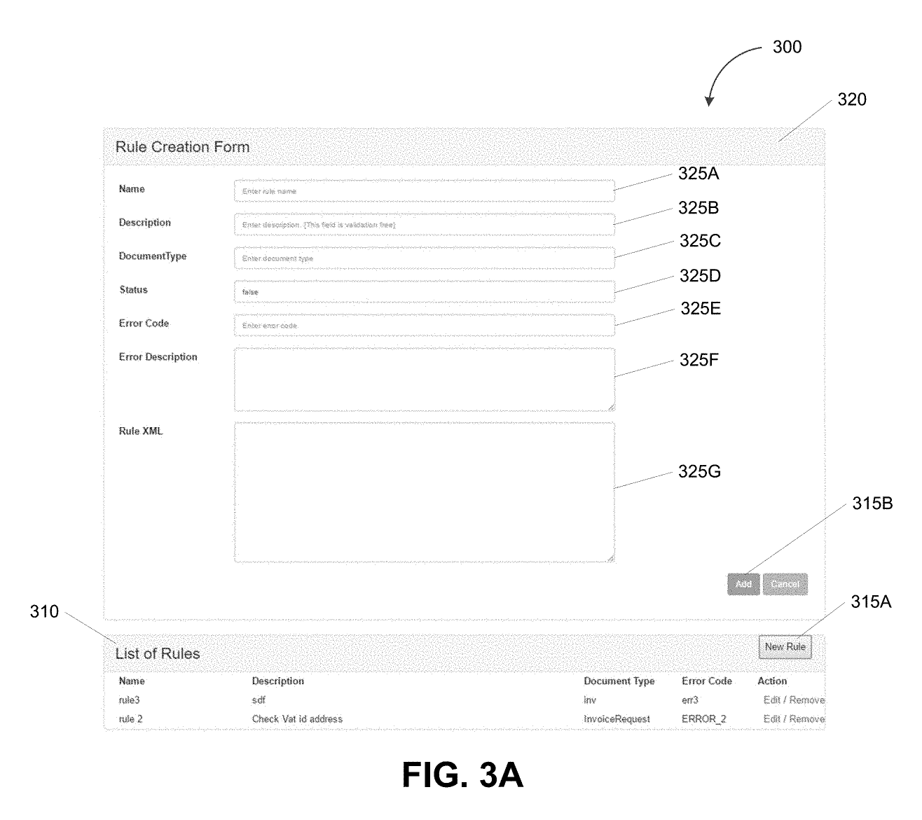

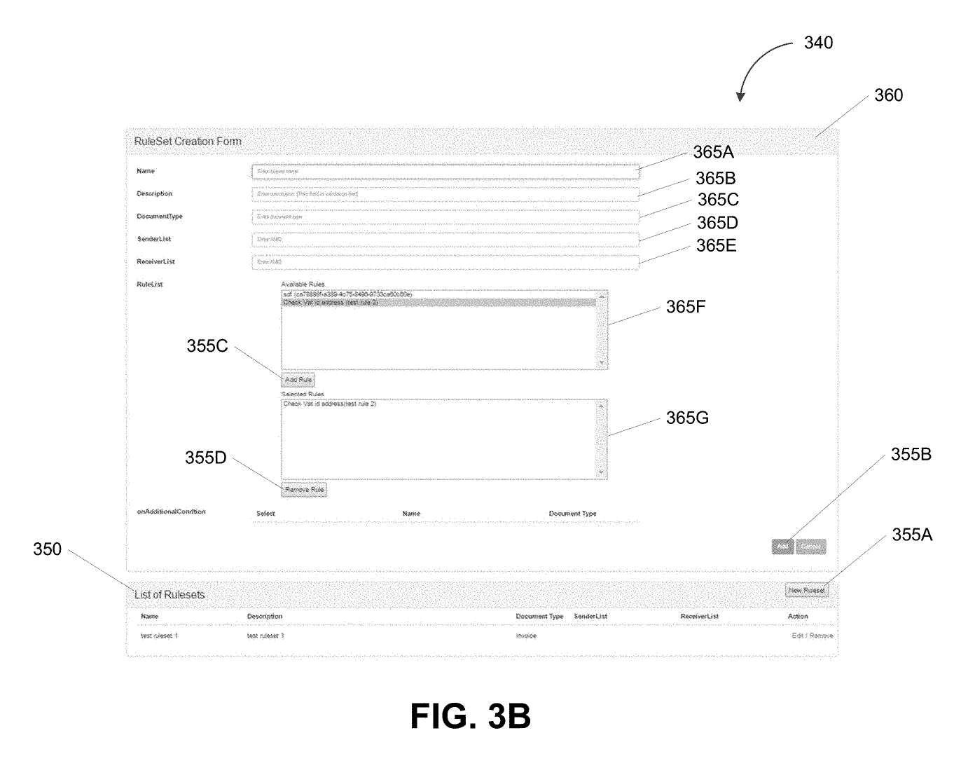

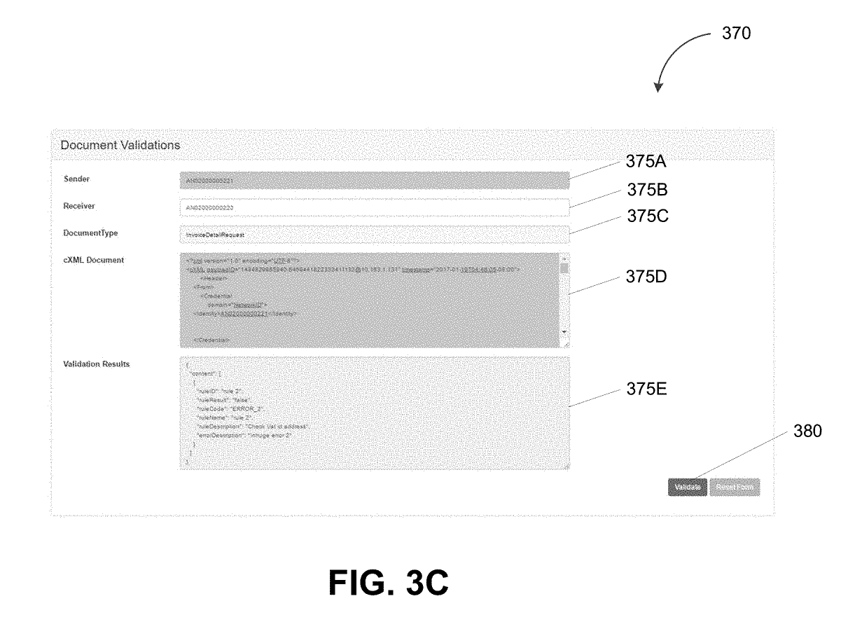

To further illustrate, FIG. 3A depicts a user interface 300 for creating a custom validation rule, in accordance with some example embodiments. In some example embodiments, the user interface 300 may be displayed by a first browser 125A at the first client 120A and/or a second browser 125B at the second client 120B. The user interface 300 may include a first pane 310 and a second pane 320. To create a new validation rule, a user of the first client 125A and/or the second client 120B may click on a first button 315A in the first pane 310 labeled “New Rule.” Clicking on the first button 315A may cause a Rule Creation Form to be displayed in the second pane 320. Alternatively and/or additionally, clicking on the first button 315A may refresh the fields included in the Rule Creation Form.

As noted, the Rule Creation Form may be displayed in the second pane 320. The second pane 320 may include a plurality of input fields for creating a validation rule including, for example, a first input field 325A for entering a name of the validation rule, a second input field 325B for entering a description for the validation rule, and a third input field 325C for entering a type of electronic document associated with the validation rule. It should be appreciated that the structured data validation engine 110 may apply a validation rule having the name entered in the first input field 325A and/or the description entered in the second input field 325B on electronic documents having the document type entered in the third input field 325C. Furthermore, the second pane 320 may also include a fourth input field 325D for entering a status associated with applying the validation rule, a fifth input field 325E for entering an error code associated with the status, and a sixth field 325F for entering a description of the error. It should be appreciated that the structured data validation engine 110 may output an error having the error code entered in the fifth input field 325E and/or the error description entered in the sixth input field 325F when the status of applying the validation rule corresponds to the status entered in the fourth input field 325D. The second pane 320 may also include a seventh field 325G for entering programming code (e.g., XML, JSON, and/or the like) implementing the validation rule.

Once the user of the first client 120A and/or the second client 120B completes the Rule Creation Form, the user may click on a second button 315B labeled “Add.” Clicking on the second button 315B may cause the new validation rule to be stored to the database 115. Furthermore, clicking on the second button 315B may cause the new validation rule to be added to the List of Rules displayed in the first pane 310.

In some example embodiments, the structured data validation engine 110 may also provide one or more default validation rules. Default validation rules may supplement and/or replace custom validation rules created by, for example, the first client 120A and/or the second client 120B. Alternatively and/or additionally, the first client 120A and/or the second client 120B may create a custom validation rule by modifying one or more default validation rules. The database 115 may store a plurality of custom validation rules and/or default validation rules. To validate structured data from the first client 120A and/or the second client 120B, the structured data validation engine 110 may identify an applicable validation rule set and retrieve, by at least querying the database 115, the validation rules (e.g., custom validation rules and/or default validation rules) included in the applicable validation rule set.

Table 3 below depicts programming code implementing a validation rule with the rule name “REQ_SUP_BANK_INFO.” The “REQ_SUP_BANK_INFO” validation rule may be applied by the structured data validation engine 110 to ensure that invoices from suppliers include bank account details. In some example embodiments, the “REQ_SUP_BANK_INFO” validation rule may be a custom validation rule created by the first client 120A and/or the second client 120B. Alternatively and/or additionally, the “REQ_SUP_BANK_INFO” validation rule may be a default validation rule provided by the structured data validation engine 110. In some example embodiments, the “REQ_SUP_BANK_INFO” validation rule may be stored in the database 115 and may be retrieved by the structured data validation engine 110 in order to validate structured data from the first client 120A and/or the second client 120B. To apply the “REQ_SUP_BANK_INFO” validation rule, the structured data validation engine 110 may execute the corresponding programming code depicted in Table 3.

```
TABLE 3
<rule name=“REQ_SUP_BANK_INFO” description=“Require suppliers to include bank
account details on invoices”>
  <class name=“cxml” value=“com.ariba.schemas.cxml2.v1_2_029.CXML”/>
  <class name=“RuleMetaData” value=“com.ariba.ruleengine.base.RuleMetaData”/>
  <variable name=“MetaData” value=“com.ariba.ruleengine.base.RuleMetaData”/>
  <variable name=“Wire”
value=“xpath:cxml/request/cxmlRequests/value/invoiceDetailRequestHeader/invoicePartner[contact/
@role=‘wireReceivingBank’]”/>
  <variable name=“Receiving”
value=“xpath:cxml/request/cxmlRequests/value/invoiceDetailRequestHeader/invoicePartner[contact/
@role=‘receivingBank’]”/>
  <if leftTerm=“xpath:$Receiving/idReference[@domain=‘accountID’]/@identifier”
operator=“notnullorempty”>
  <then>
    <if leftTerm=“xpath:$Receiving/idReference[@domain=‘bankRoutingID’]/@identifier”
operator=“notnullorempty”>
    <else>
      <action method=“java:appendToRuleErrorMessage( )”/>
    </else>
    </if>
  <then>
  <else>
  <if leftTerm=“xpath:$Wire/idReference[@domain=‘accountID’]/@identifier”
operator=“notnullorempty”>
    <then>
    <if leftTerm=“xpath:$Wire/idReference[@domain=‘swiftID’]/@identifier”
operator=“notnullorempty”>
      <else>
      <action method=“java:appendToRuleErrorMessage( )”/>
      </else>
    </if>
    </then>
  </if>
  </else>
  </if>
</rule>
```

In some example embodiments, the first client 120A and/or the second client 120B may each create one or more validation rule sets. Each validation rule set may be associated with a type of electronic document, a group of senders, and/or a group of receivers. As such, the structured data validation engine 110 may generate the appropriate validation rule set to validate the structured data included in different electronic documents. For instance, the first client 120A may create a first validation rule set that includes exclusive custom validation rules created by the first client 120A, shared custom validation rules created by the first client 120A, shared custom validation rules created by the second client 120B, and/or default validation rules provided by the structured data validation engine 110. The first client 120A may associate the first validation rule set with a first type of electronic document (e.g., purchase order, invoice, and/or the like), a first group of senders, and/or a first group of receivers. Alternatively and/or additionally, the second client 120B may create a second validation rule set that includes exclusive custom validation rules created by the second client 120B, shared custom validation rules created by the first client 120A, shared custom validation rules created by the second client 120B, and/or default validation rules provided by the structured data validation engine 110. The second client 120B may associate this second validation rule set with the first type of electronic document and/or a second type of electronic document, the first group of senders and/or a second group of senders, and/or the first group of receivers and/or a second group of receivers.

To further illustrate, FIG. 3B depicts a user interface 340 for creating a validation rule set, in accordance with some example embodiments. In some example embodiments, the user interface 340 may be displayed by the first browser 125A at the first client 120A and/or the second browser 125B at the second client 120B. The user interface 340 may include a first pane 350 and a second pane 360. To create a new validation rule, a user of the first client 125A and/or the second client 120B may click on a first button 355A in the first pane 350 labeled “New Ruleset.” Clicking on the first button 355A may cause a RuleSet Creation Form to be displayed in the second pane 360. Alternatively and/or additionally, clicking on the first button 355A may refresh the fields included in the RuleSet Creation Form.

As noted, the RuleSet Creation Form may be displayed in the second pane 360. The second pane 360 may include a plurality of input fields for creating a validation rule set including, for example, a first input field 365A for entering a name of the validation rule set, a second input field 365B for entering a description for the validation rule set, a third input field 365C for entering a type of electronic document associated with the validation rule set, a fourth input field 365D for entering a list of senders associated with the validation rule set, and a fifth input field 365E for entering a list of receivers associated with the validation rule set. The structured data validation engine 110 may be configured to apply a rule set having the name entered in the first input field 365A and/or the description entered in the second input field 365B when validating an electronic document that has the document type entered in the third input field 365C, originates from a sender in the sender list entered in the fourth input field 365D, and/or is destined for a receiver in the receiver list entered in the fifth input field 365E.

Furthermore, the second pane 320 may also include a sixth field 365F displaying a list of available rules and a seventh field 365G displaying a list of selected rules added to the rule set. As shown in FIG. 3B, the user of the first client 120A and/or the second client 120B may add one or more validation rule from the list of available rules to the list of selected rules by selecting one or more of the available rules shown in the sixth field 365F and clicking on a third button 355C labeled “Add Rule.” Clicking on the third button 355C may add the selected rules to the list of selected rules shown in the seventh field 365G. Alternatively and/or additionally, the user of the first client 120A and/or the second client 120B may remove one or more validation rule from the list of selected rules shown in the seventh field 365G by selecting one or more of the selected rules shown in the seventh field 365G and clicking on the fourth button 355D.

Once the user of the first client 120A and/or the second client 120B completes the RuleSet Creation Form, the user may click on a second button 355B labeled “Add.” Clicking on the second button 355B may cause the new validation rule set to be stored to the database 115. Furthermore, clicking on the second button 355B may cause the new validation rule set to be added to the List of Rulesets displayed in the first pane 350.

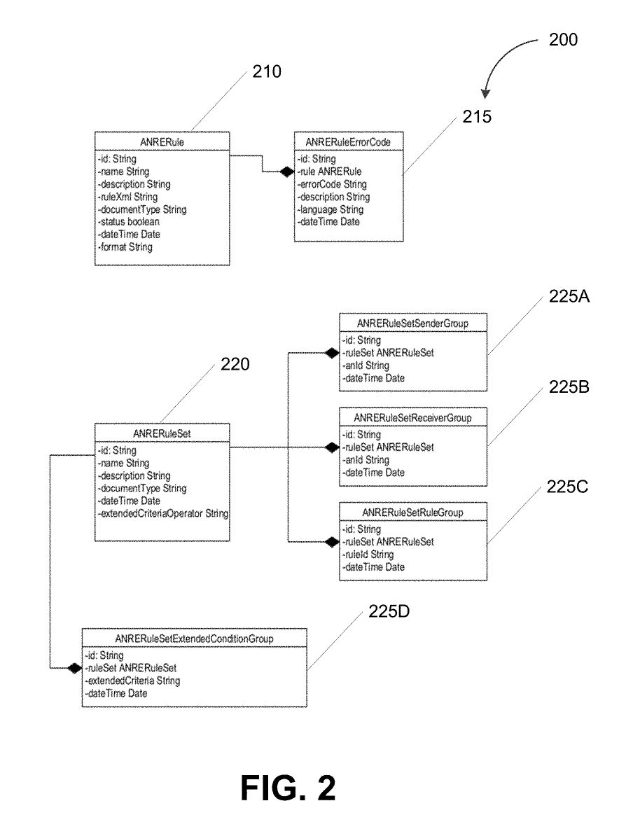

As noted, the database 115 may be configured to store one or more validation rules and/or validation rule sets. To further illustrate, FIG. 2 depicts a data model 200 for storing validation rules and/or validation rule sets at the database 115, in accordance with some example embodiments. In some example embodiments, validation rules and validation rule sets may be stored at the database 115 in accordance with the data model 200. As shown in FIG. 2, the data model 200 may include a plurality of data objects. For instance, the data model 200 may include a rule object 210. Each validation rule stored in the database 115 may be an instance of the rule object 210. For instance, an instance of the rule object 210 may be generated based on the information provided via the Rule Creation Form shown in the user interface 300. The rule object 210 may include one or more attributes associated with a validation rule including, for example, an identifier, a name, a description, XML implementing the rule, a type of electronic document associated with the rule, a date and/or time, a format, and/or the like. The rule object 210 may be related to a rule error code object 215, which may include attributes associated with the error that is triggered by failing the validation rule associated with the rule object 210.

The data model 200 may further include a rule set object 220. Each validation rule set stored in the database 115 may be an instance of the rule set object 220. As shown in FIG. 2, the rule set object 220 may include one or more attributes associated with a validation rule set including, for example, an identifier, a name, a description, a type of electronic document associated with the rule set, a date and/or time, and/or an extended criteria operator. The rule set object 220 may be related to a rule set sender group object 225A, a rule set receiver group object 225B, a rule set rule group 225C, and/or a rule set extended condition group 225D. Information entered into the RuleSet Creation Form shown in user interface 340 may be used to create instances of the rule set object 220, the rule set sender group object 225A, the rule set receiver group object 225B, the rule set rule group 225C, and/or the rule set extended condition group 225D

In some example embodiments, the first client 120A and/or the second client 120B may send, to the structured data validation engine 110, one or more electronic documents including structured data for validation. The structured data may be in the form of, for example, XML documents, JSON documents, and/or the like. In response to receiving the one or more electronic documents, the structured data validation engine 110 may identify an applicable validation rule set and retrieve, by at least querying the database 115, one or more validation rules included in the applicable validation rule set. The structured data validation engine 110 may further validate the structured data included in the electronic documents by at least applying the validation rules retrieved from the database 115. To further illustrate, FIG. 3C depicts a user interface 370 for validating structured data, in accordance with some example embodiments. In some example embodiments, the user interface 340 may be displayed by the first browser 125A at the first client 120A and/or the second browser 125B at the second client 120B.

As shown in FIG. 3C, the user interface 370 may display a Document Validations Form. To validate an electronic document that includes structured data, the user of the first client 120A and/or the second client 120B may complete the Document Validations Form displayed in the user interface 370. For instance, the user interface 370 may include a first input field 375A for entering a sender of the electronic document, a second input field 375B for entering a receiver of the electronic document, a third input field 375C for entering a type of the electronic document, and a fourth input field 375D for entering the structured data (e.g., XML, JSON, and/or the like) included in the electronic document. When the user inputs the necessary data into the first input field 375A, the second input field 375B, the third input field 375C, and/or the fourth input field 375D, the user of the first client 120A and/or the second client 120B may click on a button 380 labeled “Validate.” Clicking on the button 380 may cause the data input into the first input field 375A, the second input field 375B, the third input field 375C, and/or the fourth input field 375D to be sent to the structured data validation engine 110.

According to some example embodiments, the structured data validation engine 110 may validate the structured data entered in the fourth input field 375D by identifying an applicable validation rule set. For instance, the structured data validation engine 110 may identify the applicable validation rule set based on the sender of the electronic document entered in the first input field 375A, the receiver of the electronic document entered in the second input field 375B, and/or the type of the electronic document entered in the third input field 375C. The structured data validation engine 110 may further retrieve, by at least querying the database 115, the validation rules included in the applicable validation rule set. These validation rules may be applied in order to validate the structured data entered in the fourth input field 375D. The structured data validation engine 110 may return a result of the validation to the first client 120A and/or the second client 120B, where the result may be displayed in a fifth field 375D in the user interface 370.

FIG. 1B depicts a block diagram illustrating the structured data validation engine 110, in accordance with some example embodiments. Referring to FIGS. 1A-B, 2, and 3A-C, the structured data validation engine 110 may include a validation rule coordinator 145A, a validation rule SET identifier 145B, a validation rule retriever 145C, and a structured data validator 145D. It should be appreciated that the structured data validation engine 110 may include additional and/or different components than shown.

In some example embodiments, the validation rule coordinator 145A may be configured to respond to requests from the first client 120A and/or the second client 120B to create, update, and/or delete a validation rule by at least creating, updating, and/or deleting the validation rule. For instance, the validation rule coordinator 145A may create, update, and/or delete a validation rule by at least querying the database 115. The database 115 may be queried by executing one or more database queries including, for example, one or more Structured Query Language (SQL) statements such as, for example, create, get, select, and/or the like.

The validation rule set identifier 145B may be configured to identify an applicable validation rule set for validating structured document included in an electronic document received from the first client 120A and/or the second client 120B. For example, the validation rule identifier 145B may identify the validation rule set that is applicable to the electronic document based on one or more attributes associated with the electronic document, including, for example, the sender of the electronic document, the receiver of the electronic document, the type of the electronic document, and/or the like. In some example embodiments, the validation rule retriever 145C may query the database 115 for example, by executing one or more database queries, in order to retrieve the validation rules included in the validation rule set applicable to the electronic document. For instance, the validation rule retriever 145C may query the database 115 by executing one or more database queries including, for example, SQL statements and/or the like.

In some example embodiments, the structured data validator 145D may validate the structured data included in the electronic document by at least applying the validation rules included in the validation rule set. For instance, the structured data validator 145D may apply a validation rule to validate the structured data by at least executing the programming code associated with the validation rule.

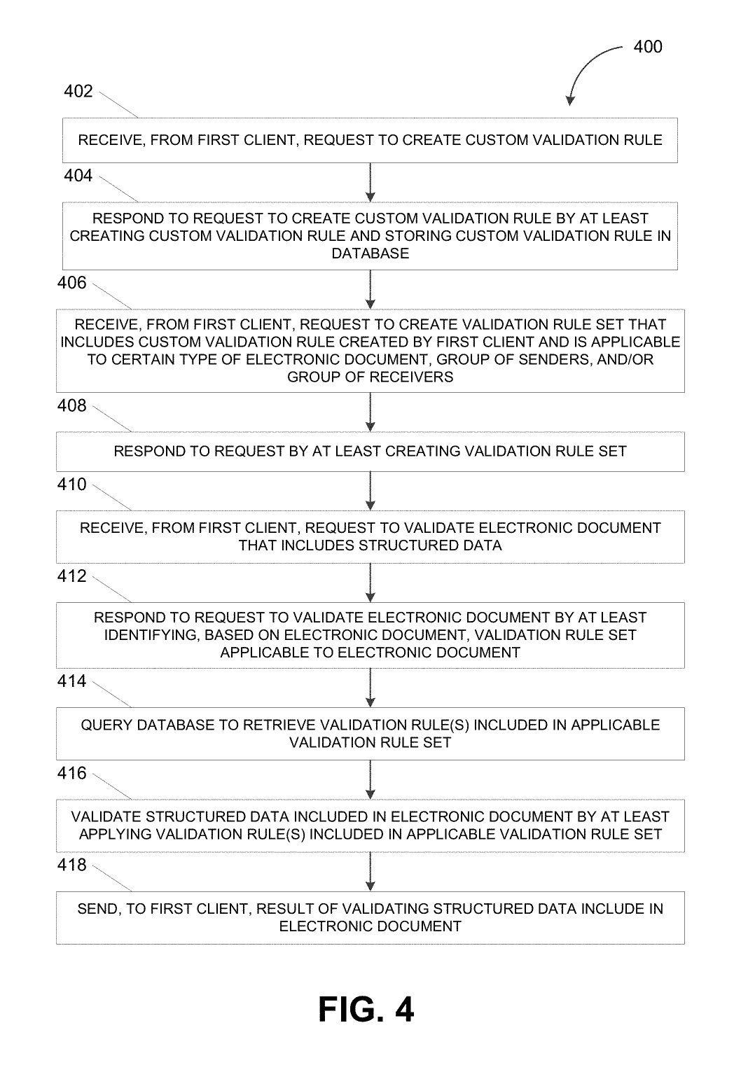

FIG. 4 depicts a flowchart illustrating a process 400 for validating structured data, in accordance with some example embodiments. Referring to FIGS. 1A-B. 2, 3A-C, and 4, the process 400 may be performed by the structured data validation engine 110.

At 402, the structured data validation engine 110 may receive, from a first client, a request to create a custom validation rule. For example, the structured data validation engine 110 may receive, from the first client 120A, a request to create a custom validation rule. As shown in FIG. 3A, the user of the first client 120A may create a custom validation rule by at least completing the Rule Creation Form shown in the user interface 300 displayed by the first browser 125A at the first client 120A. In some example embodiments, the first client 120A may create an exclusive custom validation rule that may only be used by the first client 120A. Alternatively and/or additionally, the first client 120A may create a shared custom validation rule that may be used by other clients of the structured data validation engine 110 including, for example, the second client 120B.

At 404, the structured data validation engine 110 may respond to the request to create the custom validation rule by at least creating the custom validation rule and storing the custom validation rule in the database 115. For example, the structured data validation engine 110 may respond to the request from the first client 120A by at least creating the custom validation rule and string the custom validation rule in the database 115.

At 406, the structured data validation engine 110 may receive, from the first client, a request to create a validation rule set that includes the custom validation rule created by the first client and is applicable to a certain type of electronic documents, group of senders, and/or group of receivers. At 408, the structured data validation engine 110 may respond to the request to create the validation rule set by at least creating the validation rule set. In some implementations of the current subject matter, the user of the first client 120A may create a validation rule set via, for example, the RuleSet Creation Form shown in the user interface 340. For instance, the user of the first client 120A may specify the validation rules that are included in the validation rule set. Furthermore, the user of the first client 120A may indicate that the type of electronic documents, the group of senders, and/or the group of receivers that the validation rule set is applicable to. It should be appreciated that the validation rule set may include exclusive custom validation rules created by the first client 120A, shared custom validation rules created by the first client 120A, shared custom validation rules created by the second client 120B, and/or a default validation rule provided by the structured data validation engine 110.

At 410, the structured data validation engine 110 may receive, from the first client, a request to validate an electronic document that includes structured data. For instance, the first client 120A may send, to the structured data validation engine 110, a request to validate an electronic document such as, for example, a purchase order, an invoice, a confirmation, and/or the like. The electronic document may include structured data in the form of XML, JSON, and/or the like. As shown in FIG. 3C, the first client 120A may request the validation of structured data by at least completing the Document Validations Form shown in user interface 370, which may displayed by the first browser 125A at the first client 120A.

At 412, the structured data validation engine 110 may respond to the request to validate the electronic document by at least identifying, based on the electronic document, a validation rule set that is applicable to the electronic document. In some example embodiments, the structured data validation engine 110 may identify the applicable validation rule set based on one or more attributes of the electronic document including, for example, the sender of the electronic document, the receiver of the electronic document, the type of the electronic document, and/or the like. As noted, the first client 120A and/or the second client 120B may associated a validation rule set with a specific type of electronic document, group of sender, and/or group of receivers. Thus, the validation rule set that is applicable to the electronic document may be the validation rule set that is associated with the electronic document based on the type of the electronic document, a sender of the electronic document, and/or a receiver of the electronic document. It should be appreciated that the applicable validation rules may include exclusive custom validation rules created by the first client 120A and/or the second client 120B, shared custom validation rules created by the first client 120A and/or the second client 120B, and/or default validation rules provided by the structured data validation engine 110. The structured data validation engine 110 may generate a validation rule set that includes the applicable validation rules.

At 414, the structured data validation engine 110 may query the database 115 to retrieve one or more validation rules included in the applicable validation rule set. For example, the structured data validation engine 110 may execute one or more database queries (e.g., SQL statements) in order to retrieve, from the database 115, the validation rules included in the validation rule set applicable to the electronic document. At 416, the structured data validation engine 110 may validate the structured data included in the electronic document by at least applying the one or more applicable validation rules included in the validation rule set. For instance, the structured data validation engine 110 may apply a validation rule by at least executing the programming code implementing the validation rule.

At 418, the structured data validation engine 110 may send, to the first client 120A, a result of validating the structured data included in the electronic document. For instance, as shown in FIG. 3C, the result of validating structured data included in the electronic document may be shown in the user interface 370 (e.g., the fifth field 375E) displayed by the first browser 125A at the first client 120A.

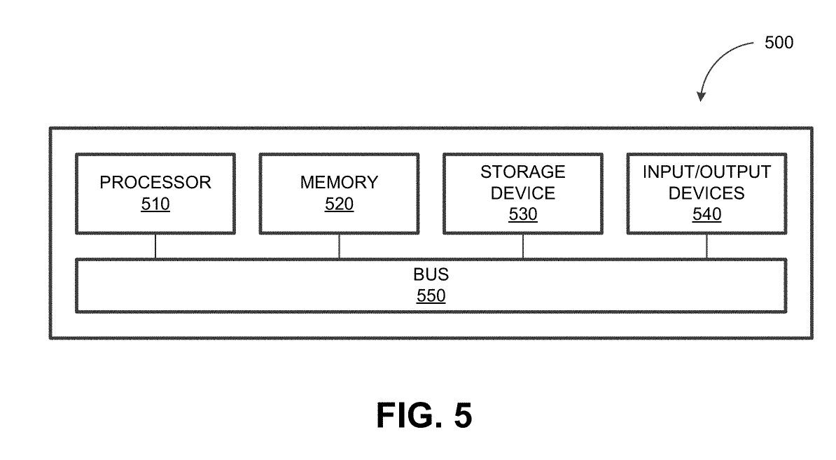

FIG. 5 depicts a block diagram illustrating a computing system 500 consistent with implementations of the current subject matter. Referring to FIGS. 1 and 5, the computing system 500 can be used to implement the structured data validation engine e110 and/or any components therein.

As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The processor 510 is capable of processing instructions for execution within the computing system 500. Such executed instructions can implement one or more components of, for example, the structured data validation engine 110. In some example embodiments, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some example embodiments, the input/output device 540 includes a keyboard and/or pointing device. In various implementations, the input/output device 540 includes a display unit for displaying graphical user interfaces.

According to some example embodiments, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some example embodiments, the computing system 500 can be used to execute various interactive computer software applications that can be used for organization, analysis and/or storage of data in various formats. Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning as an add-in for a spreadsheet and/or other type of program) or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A system, comprising:
at least one data processor; and
at least one memory storing instructions which, when executed by the at least one data processor, cause operations comprising:
receiving, at a structured data validation engine and from a first client, a first request to validate an electronic document comprising structured data;
responding to the first request by at least identifying a set of validation rules for validating the structured data comprising the electronic document, the set of validation rules being identified by the structured data validation engine and being identified based at least on one or more attributes associated with the electronic document;
sending, to a database storing a plurality of validation rules, one or more database queries to at least retrieve, from the database, a first validation rule included in the set of validation rules; and
validating the structured data by at least applying the first validation rule to the structured data.

2. The system of claim 1, further comprising:
generating a first user interface comprising one or more input fields for entering the structured data and the one or more attributes associated with the electronic document, the first user interface being displayed at the first client, and the first request being received via the first user interface.

3. The system of claim 1, further comprising:
receiving, from the first client, a second request to create the first validation rule; and
responding to the second request by at least creating, at the database, one or more data objects corresponding to the first validation rule.

4. The system of claim 3, further comprising:
generating a second user interface comprising one or more input fields for entering a name of the first validation rule, a description of the first validation rule, and/or a type of electronic document associated with the first validation rule, the second user interface being displayed at the first client, and the second request being received via the second user interface.

5. The system of claim 1, wherein the set of validation rules further includes a second validation rule created by a second client and/or a third validation rule provided by the structured data validation engine.

6. The system of claim 5, wherein the first validation rule comprises an exclusive validation rule useable by the first client but not the second client.

7. The system of claim 5, wherein the second validation rule comprises a shared validation rule useable by the first client and/or the second client.

8. The system of claim 5, further comprising:
receiving, from the first client, a third request to create the set of validation rules that includes the first validation rule, the second validation rule, and/or the third validation rule, the third request associating the set of validation rules with the one or more attributes such that the set of validation rules is applied to validate electronic documents having the one or more attributes; and
responding to the third request by at least creating, at the database, one or more data objects corresponding to the set of validation rules.

9. The system of claim 8, wherein the one or more attributes includes a type of the electronic document, a sender of the electronic document, and/or a receiver of the electronic document.

10. The system of claim 1, further comprising:
sending, to the first client, a result of validating the structured data comprising the electronic document, the sending of the result enabling the result to be displayed by a browser at the first client.

11. The system of claim 1, wherein the structured data is validated by at least executing programming code associated with the first validation rule.

12. The system of claim 1, wherein the structured data comprises Extensible Markup Language (XML) and/or JavaScript Object Notation (JSON).

13. The system of claim 1, wherein the structured data validation engine comprises a cloud-based platform.

14. A computer-implemented method, comprising:
receiving, at a structured data validation engine and from a first client, a first request to validate an electronic document comprising structured data;
responding to the first request by at least identifying a set of validation rules for validating the structured data comprising the electronic document, the set of validation rules being identified by the structured data validation engine and being identified based at least on one or more attributes associated with the electronic document;
sending, to a database storing a plurality of validation rules, one or more database queries to at least retrieve, from the database, a first validation rule included in the set of validation rules; and
validating the structured data by at least applying the first validation rule to the structured data.

15. The method of claim 14, further comprising:
generating a first user interface comprising one or more input fields for entering the structured data and the one or more attributes associated with the electronic document, the first user interface being displayed at the first client, and the first request being received via the first user interface.

16. The method of claim 14, further comprising:
receiving, from the first client, a second request to create the first validation rule; and
responding to the second request by at least creating, at the database, one or more data objects corresponding to the first validation rule.

17. The method of claim 16, further comprising:
generating a second user interface comprising one or more input fields for entering a name of the first validation rule, a description of the first validation rule, and/or a type of electronic document associated with the first validation rule, the second user interface being displayed at the first client, and the second request being received via the second user interface.

18. The method of claim 14, wherein the set of validation rules further includes a second validation rule created by a second client and/or a third validation rule provided by the structured data validation engine.

19. The method of claim 18, further comprising:
receiving, from the first client, a third request to create the set of validation rules that includes the first validation rule, the second validation rule, and/or the third validation rule, the third request associating the set of validation rules with the one or more attributes such that the set of validation rules is applied to validate electronic documents having the one or more attributes; and
responding to the third request by at least creating, at the database, one or more data objects corresponding to the set of validation rules.

20. A non-transitory computer readable medium storing instructions, which when executed by at least one data processor, result in operations comprising:
receiving, at a structured data validation engine and from a first client, a first request to validate an electronic document comprising structured data;
responding to the first request by at least identifying a set of validation rules for validating the structured data comprising the electronic document, the set of validation rules being identified by the structured data validation engine and being identified based at least on one or more attributes associated with the electronic document;
sending, to a database storing a plurality of validation rules, one or more database queries to at least retrieve, from the database, a first validation rule included in the set of validation rules; and
validating the structured data by at least applying the first validation rule to the structured data.
